(19) United States
(12) Patent Application Publication
(10) Pub. No.: US 2020/0156691 A1
(43) Pub. Date: May 21, 2020

(54) VEHICULAR STEERING WHEEL

(71) Applicants: Hyundai Motor Company, Seoul (KR); Kia Motors Corporation, Seoul (KR)

(72) Inventors: Un Jae JUNG, Osan-si (KR); Sung Joon WANG, lncheon (KR)

(73) Assignees: Hyundai Motor Company, Seoul (KR); Kia Motors Corporation, Seoul (KR)

(21) Appl. No.: 16/286,884

(22) Filed: Feb. 27, 2019

(30) Foreign Application Priority Data
Nov. 16, 2018 (KR) 10-2018-0141389

(51) Int. Cl. B62D 1/11; B62D 1/10; B60R 21/203

(52) U.S. Cl. CPC B62D 1/11; B60R 21/203; B62D 1/10

(57) ABSTRACT

A vehicular steering wheel may include a wheel hub coupled to a center portion of the steering wheel and connected to a steering shaft; a damper plate mounted on the wheel hub to overlap the wheel hub and configured to fasten an airbag module thereto; and an elastic fastener configured to connect the wheel hub and the damper plate to provide an elastic force to the damper plate.

### CROSS REFERENCE TO RELATED APPLICATION

The present application claims priority to Korean Patent Application No. 10-2018-0141389, filed Nov. 16, 2018, the entire contents of which is incorporated herein for all purposes by this reference.

### BACKGROUND OF THE INVENTION

### Field of the Invention

The present invention relates to a vehicular steering wheel that utilizes an airbag module as a mass for damping.

### Description of Related Art

During traveling of a vehicle and idling of an engine, vibration occurs in the steering wheel due to vibrations transmitted from the engine and the tires.

When the steering wheel excessively vibrates, the driver may feel uncomfortable, resulting in a problem of deteriorated marketability of the vehicle.

To improve this, a structure has been provided in which a damper is applied to the internal to the steering wheel or a damping structure is applied to the inflator of a driver seat airbag.

However, when the damper is placed inside the steering wheel, a lack of space is caused inside the steering wheel. Thus, it is impossible to increase the mass of the damper beyond a predetermined level, whereby a vibration reduction effect is not so high.

When the damping structure is applied to the inflator, the weight of the inflator itself may be utilized as a damping structure, and thus the vibration reduction effect is relatively high. However, a space is formed by movement due to the damping operation, and thus there is a problem in that gas leaks into this space during the deployment of the airbag.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a vehicular steering wheel that utilizes an airbag module as a mass for damping.

In view of the problems described above, a configuration of the present invention may include: a wheel hub coupled to a center portion of the steering wheel and connected to a steering shaft; a damper plate mounted on the wheel hub to overlap the wheel hub and configured to fasten an airbag module thereto; and an elastic fastener configured to connect the wheel hub and the damper plate to provide an elastic force to the damper plate.

The wheel hub and the damper plate may be sandwiched between and tightly supported by opposite end portions of the elastic fastener.

A first gap may be formed between the wheel hub and the damper plate by the elastic fastener, and in the process in which the damper plate moves in the width direction of the first gap, the elastic fastener may allow the movement of the damper plate while being elastically deformed.

The wheel hub and the damper plate may be provided with a first fastening hole and a second fastening hole, respectively, the elastic fastener may be provided through the first and second fastening holes, and a plurality of flanges, each of which is formed in a circumferential direction of an external circumferential surface of the elastic fastener, may be provided in a longitudinal direction of the elastic fastener. A flange in a middle portion of the elastic fastener may be tightly supported by each of internal surfaces of the wheel hub and the damper plate, which face each other, and flanges at opposite end portions of the elastic fastener may be tightly supported on external surfaces of the wheel hub and the damper plate, respectively.

The vehicular steering wheel may further include a fastening bolt configured to fasten the wheel hub and the damper plate.

A bolt-fastening hole may be formed in the wheel hub, and a bolt insertion hole may be formed in the damper plate. An end portion of a body of the fastening bolt may be bolted into the bolt-fastening hole, a remaining portion of the body may be inserted into the bolt insertion hole, and a predetermined second gap may be formed between a top surface of the damper plate, which is connected to the bolt insertion hole, and a head of the fastening bolt.

With the configuration of the present invention described above, since the damper plate coupled to an airbag module is connected to the wheel hub by an elastic fastener, the airbag module may be utilized as a mass for damping to absorb vibration. Therefore, the vibration transmitted to the steering wheel is more effectively reduced, and actual vehicle Noise, vibration, harshness (NVH) performance is significantly improved.

Furthermore, since the damping structure is implemented by adding only simple structures such as a plate and an elastic body to the airbag module mounted in the steering wheel, excellent damping performance may be exhibited while reducing costs and weight compared to a separately disposed damper.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view exemplarily illustrating the state in which a wheel hub is assembled to a steering wheel according to an exemplary embodiment of the present invention;

FIG. 2 is a view exemplarily illustrating the state in which a damper plate is assembled to a wheel hub according to an exemplary embodiment of the present invention;

FIG. 3 is a view exemplarily illustrating the state in which an airbag module is coupled to a damper plate according to an exemplary embodiment of the present invention; and

FIG. 4 is a cross-sectional view taken along line A-A′ in FIG. 2.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the other hand, the invention(s) is/are intended to cover not only the exemplary embodiments, but also various alternatives, modifications, equivalents and other embodiments, which may be included within the spirit and scope of the invention as defined by the appended claims.

Hereinafter, embodiments of the present invention will be described in detail with reference to the accompanying drawings.

A vehicular steering wheel 1 according to an exemplary embodiment of the present invention includes a wheel hub 10, a damper plate 20, and elastic fasteners 30.

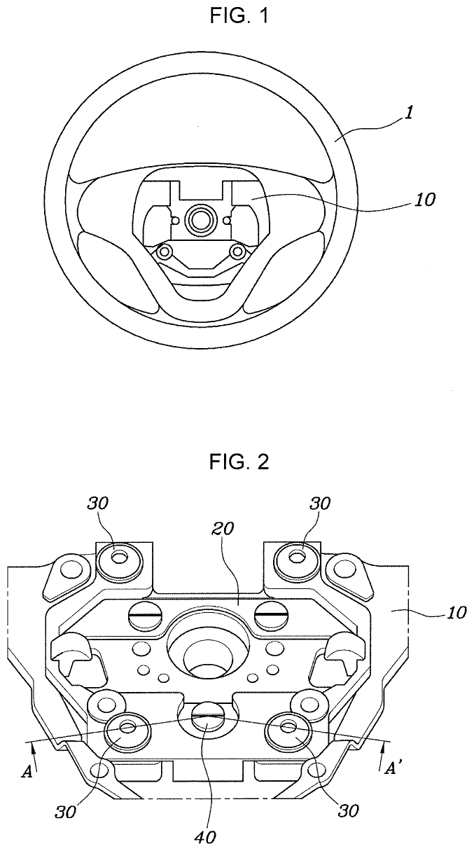

As illustrated in FIG. 1, the wheel hub 10 is coupled to the center portion of the steering wheel 1, and a steering shaft is inserted into a center hole.

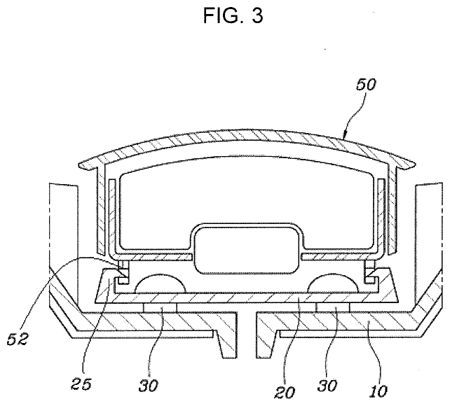

Furthermore, as illustrated in FIG. 2 and FIG. 3, a damper plate 20 is mounted on the wheel hub 10 to overlap a portion of the wheel hub 10, and the airbag module 50 is fastened to the damper plate 20.

For example, hooks 25 are formed on opposite end portions of the damper plate 20, hooking holes 52 corresponding to the hooks 25 are formed in opposite end portions of the lower portion of the airbag module 50, and the airbag module 50 is fastened to the damper plate 20 by the engagement structure between the hooks 25 and the hooking holes 52.

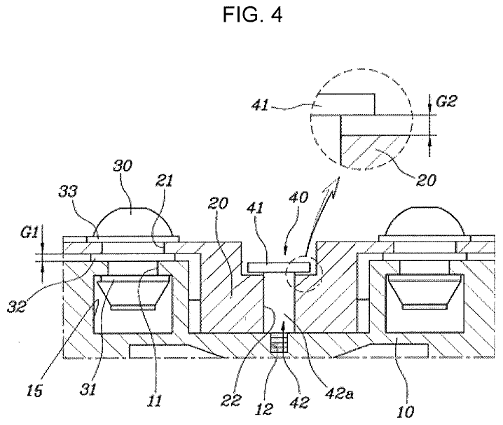

Furthermore, as illustrated in FIG. 4, the wheel hub 10 and the damper plate 20 are connected to each other by elastic fasteners 30, forming a structure that provides elastic force to the damper plate 20 via the elastic fasteners 30.

That is, since the damper plate 20 to which the airbag module 50 is coupled is connected to the wheel hub 10 by the elastic fasteners 30, the airbag module 50 coupled to the damper plate 20 is utilized as a mass for damping to absorb the vibration in the process in which the vibration transmitted to the steering wheel 1 is transmitted to the damper plate 20 through the elastic fasteners 30, so that the vibration transmitted to the steering wheel 1 may be more effectively reduced.

Furthermore, the elastic fasteners 30 are made of an elastic material, and have a structure in which the wheel hub 10 and the damper plate 20 are sandwiched between and tightly supported by the opposite end portions of the elastic fasteners 30.

Furthermore, since the wheel hub 10 and the damper plate 20 are sandwiched between the opposite end portions of the elastic fasteners 30, a first gap G1 is formed between the wheel hub 10 and the damper plate 20, and in the process in which the damper plate 20 moves in the width direction of the first gap G1, the elastic fasteners 30 allow the movement of the damper plate 20 while being elastically deformed. Therefore, the elastic fasteners 30 may be set to have a frequency configured for appropriately damping the vibration transmitted to the steering wheel 1 through the adjustment of rigidity.

That is, when the vibration is transmitted through the steering wheel 1, the airbag module 50 coupled to the damper plate 20 is utilized as a mass and moved. At the instant time, because the elastic fasteners 30 are elastically deformed, the width of the first gap G1 changes, and the vibration transmitted to the steering wheel 1 is canceled.

A configuration in which the above-described elastic fasteners 30 are coupled is described in detail. First fastening holes 11 and second fastening holes 21 are formed in the wheel hub 10 and the damper plate 20, respectively, and the elastic fasteners 30 are provided through the first and second fastening holes 11 and 21.

A plurality of flanges, each of which is formed in the circumferential direction of the external circumferential surface of each elastic fastener 30, are provided at a predetermined interval in the longitudinal direction of each elastic fastener 30. Among the flanges of each elastic fastener 30, a second flange 32 formed in the middle portion of the elastic fastener 30 is tightly supported by each of the internal surfaces of the wheel hub 10 and the damper plate 20, which face each other.

Furthermore, among the flanges of each elastic fastener 30, first and third flanges 31 and 33 at the opposite end portions of the elastic fastener 30 are tightly supported by the external surfaces of the wheel hub 10 and the damper plate 20, respectively.

That is, the second flange 32 formed at the middle portion of each elastic fastener 30 is positioned between the wheel hub 10 and the damper plate 20, and the external diameter of the second flange 32 is greater than the internal diameters of the first fastening hole 11 and the second elastic hole 21, so that the second coupling flange 32 may be tightly supported between the wheel hub 10 and the damper plate 20.

Furthermore, the first flange 31 formed at the lower end portion of each elastic fastener 30 is positioned on the bottom surface of the wheel hub 10, and the external diameter of the first flange 31 is greater than the internal diameter of the first fastening hole 11, so that the first flange 31 may be tightly supported on the bottom surface of the wheel hub 10.

Furthermore, in an exemplary embodiment of the present invention, the first flange 31 formed at the lower end portion of each elastic fastener 30 is positioned in a groove 15 formed on the bottom surface of the wheel hub 10, and the external diameter of the first flange 31 is greater than the internal diameter of the first fastening hole 11, so that the first flange 31 may be tightly supported on the bottom surface of the wheel hub 10.

Furthermore, the third flange 33 formed at the upper end portion of each elastic fastener 30 is positioned on the top surface of the damper plate 20, in which the external diameter of the third flange 33 is greater than the internal diameter of the second fastening hole 21, so that the third flange 33 may be tightly supported on the top surface of the damper plate 20.

In an exemplary embodiment of the present invention, the internal diameter of the second fastening hole 21 is greater than the internal diameter of the first fastening hole 11.

With the present structure, the elastic fasteners 30 are able to provide an elastic force to the damper plate 20 while connecting the wheel hub 10 and the damper plate 20.

Although the wheel hub 10 and the damper plate 20 are connected to each other by the elastic fasteners 30, a structure may be further provided to prevent the damper plate 20 from escaping due to the inflation pressure of an airbag when the airbag is deployed.

For the present purpose, in an exemplary embodiment of the present invention, the wheel hub 10 and the damper plate 20 may be fastened by a plurality of fastening bolts 40, as illustrated in FIGS. 2 and 4.

Bolt-fastening holes 12 are formed in the wheel hub 10, and bolt insertion holes 22 are formed in the damper plate 20.

Thus, the end portions of the bodies 42 of the fastening bolts 40 are bolted into the bolt-fastening holes 12, respectively, and the remaining portions of the bodies 42 adjacent to the heads 41 of the fastening bolts 40 are inserted into the bolt insertion holes 22, respectively. At the instant time, a predetermined second gap G2 is formed between the top surface of the damper plate 20 connected to the bolt insertion holes 22 and the heads 41 of the fastening bolts 40.

For the present purpose, the length of the insertion bodies 42a inserted into the bolt insertion holes 22 is greater than the depth of the bolt insertion holes 22.

That is, as the vibration is transmitted to the steering wheel 1, the elastic fasteners 30 are elastically deformed and the damper plate 20 is moved up and down. At the instant time, since the bolt insertion holes 22 formed in the damper plate 20 have a length shorter than that of the insertion bodies 42a, the up-and-down movement of the damper plate 20 is not impeded and thus the vibration of the steering wheel 1 is reduced.

However, when the airbag is deployed, the inflation pressure of the airbag is applied to the damper plate 20. At the instant time, since the top surface of the damper plate 20 in which the bolt insertion holes 22 are formed, is engaged with the heads 41 of the fastening bolts 40 and the fastening bolts 40 are bolted into the wheel hub 10, the damper plate 20 is prevented from escaping.

As described above, in an exemplary embodiment of the present invention, since the damper plate 20 to which the airbag module 50 is coupled is connected to the wheel hub 10 by the elastic fasteners 30, the airbag module 50 coupled to the damper plate 20 is utilized as a mass for damping to absorb the vibration in the process in which the vibration transmitted to the steering wheel 1 is transmitted to the damper plate 20 through the elastic fasteners 30. Therefore, the vibration transmitted to the steering wheel 1 is more effectively reduced, and actual vehicle Noise, vibration, harshness (NVH) performance is significantly improved.

Furthermore, since the damping structure is implemented by adding only simple structures such as a plate and an elastic body to the airbag module 50 mounted in the steering wheel 1, excellent damping performance may be exhibited while reducing costs and weight compared to a conventional damper, which is separately disposed.

Furthermore, since the airbag module 50 itself is used as a mass body without changing the structure thereof, it is possible to solve the problem of gas loss or the like which may occur during the deployment of the airbag.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

1. A vehicular steering wheel comprising:
a wheel hub coupled to a center portion of the steering wheel and configured to be connected to a steering shaft;
a damper plate mounted on the wheel hub, wherein an airbag module is mounted on the damper plate;
an elastic fastener connecting the wheel hub and the damper plate to provide an elastic force to the damper plate; and
a fastening, bolt configured to fasten the damper plate to the wheel hub,
wherein the wheel hub and the damper plate are sandwiched between a first portion and a second portion of the elastic fastener and elastically supported by the first and second portions of the elastic fastener, and
wherein the wheel hub is provided with a first fastening hole, the damper plate is provided with a second fastening hole, and the elastic fastener is provided through the first and second fastening holes,
wherein a plurality of flanges, each of which is formed in a circumferential direction of an external circumferential surface of the elastic fastener, are provided in a longitudinal direction of the elastic fastener,
wherein first and third flanges among the plurality of flanges are formed at the first and second portions of the elastic fastener, respectively and are supported on an internal surface of the wheel hub and an external surface of the damper plate, respectively,
wherein a second flange among the plurality of flanges is formed between the first flange and the third flange in a middle portion of the elastic fastener, is located between an external surface of the wheel hub and an internal surface of the damper plate, and is in contact with and supported by each of the external surface of the wheel hub and the internal surface of the damper plate, which face each other,
wherein a first gap is formed between the wheel hub and the damper plate by the elastic fastener,
wherein, while the damper plate moves in a width direction of the first gap, the elastic fastener allows movement of the damper plate while being elastically deformed,
wherein a bolt-fastening hole is formed in the wheel hub and a bolt insertion hole is formed in the damper plate,
wherein the fastening bolt includes a head, an insertion body and an end portion,
wherein the end portion of the fastening bolt is bolted into the bolt-fastening hole and an insertion portion of the insertion body is inserted into the bolt insertion hole, and
wherein a length of the insertion body is greater than a depth of the bolt insertion hole and a predetermined second gap is formed between a top surface of the damper plate, in which the bolt insertion hole is penetrated, and the head of the fastening bolt, and the top surface of the damper plate and the head of the fastening bolt are decoupled in the predetermined second gap such that an up-and-down movement of the damper plate is not impeded and thus a vibration of the steering wheel is reduced.

2-3. (canceled)

4. The vehicular steering wheel of claim 1,
wherein the first gap is formed between the wheel hub and the damper plate by a third portion of the elastic fastener positioned between the first and second portions of the elastic fastener.

5. The vehicular steering wheel of claim 4, wherein a flange is formed on the third portion of the elastic fastener.

6. (canceled)

7. The vehicular steering wheel of claim 1,
wherein an internal diameter of the second fastening hole is greater than an internal diameter of the first fastening hole.

8. The vehicular steering wheel of claim 1,
wherein the first flange is formed at a lower end portion of the elastic fastener and is positioned in a groove formed in a body of the wheel hub.

9-10. (canceled)
